(19) United States
(12) Patent Application Publication
(10) Pub. No.: US 2016/0365749 A1
(43) Pub. Date: Dec. 15, 2016

(54) CHARGER

(71) Applicant: Tony Lin, Guang Dong (CN)

(72) Inventor: Tony Lin, Guang Dong (CN)

(21) Appl. No.: 15/180,836

(22) Filed: Jun. 13, 2016

Related U.S. Application Data
(60) Provisional application No. 62/174,276, filed on Jun. 11, 2015.

(51) Int. Cl. H02J 7/14; H02J 7/00

(52) U.S. Cl. CPC H02J 7/14; H02J 7/0045

(57) ABSTRACT

A charger is disclosed that is configured with a low profile so as to fit into a charging port of a device that may be in a case or protective housing.

This application claims priority to provisional application no. 62/147,276 filed on Jun. 11, 2015, which disclosure is incorporated by reference in its entirety herein.

### BACKGROUND OF THE INVENTION

1. Field of the Invention

The present invention to relates a charger, and more particulary, a charger for devices that may be used in, for example, a vehicle, attached to a computer, or to a wall outlet. device.

2. Background

Many chargers exist. The importance of chargers is ever increasing as the demands for battery power increase due to the increasing usage of cell phones, computers, and the like. Users have the need for battery power, while on the move including when in a vehicle. One significant issue with current chargers is that they are not usable with certain devices, especially when such devices are in protective cases. In one example, car phone chargers may plug into a cigarette lighter of a car at one end, but the plug may not fit into the charging input of the cell phone because the case includes a profile that may prevent the plug from fitting sufficiently into the charging input

Therefore, there is a need for charger for devices that allows that allows a plug to be inserted into the charging port of the device with any type of case or covering for the device.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates an exploded view of a charger in an embodiment.

FIG. 1A illustrates an exploded view of a charger in an embodiment.

FIG. 2 illustrates an exploded view of an example of a plug in an embodiment.

FIGS. 3(A)-3(D) illustrate a perspective views of the plug.

### SUMMARY

In one aspect, a charger includes a first end configured to be plugged into car power outlet, the first end comprising a back cover, an upper cover, a female receptor, a plurality of negative connectors, at least one positive connector, an LED cover; and a second end coupled to the first end by a cable, the second end including an inner told, a liquid crystal polymer, a connector, and a jacket; wherein the jacket has a relative dimension to the connector to enable the connecter to engage a charging input of a device, when the device is in a protective cover.

The jacket may have a length of about 16.00 mm and a height of about 4.80 mm, a tolerance between +/−0.05 mm-+/−20 mm. The female receptor may be a USB female receptor, and the cable may be a coil cable. The device may be one of a computer, a laptop, a mobile device, and a tablet. The charger may include a positive and negative voltage pin(s) and one of corresponding D+/D− pins configured on a chipset.

### DETAILED DESCRIPTION

Each of the additional features and teachings disclosed below can be utilized separately or in conjunction with other features and teachings to provide a device, system, and/or method for a car charger. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of les disclose every possible intermediate value or intermediate entity for the purpose of original disclosure, as well as for the purpose of restricting the claimed subject matter.

Devices, methods, and systems described for charger, such as a car charger that may be used with a variety of devices, including mobile devices, laptops, personal digital assistants (PDA), or tablets. The charger may include an end configured for a cigarette lighter, a wall outlet, or a computer port, such as a USB port. The other end of the charger may be configured to be plugged into one of a number of devices. The plug may be configured to have a size and dimension suitable to plug into a device, when the device is in a case or protective cover.

The charger may be made from Acrylonitril butadiene styrene (ABS) or Polycarbonate. The charger may have a jacket with dimensions of about 4.80 mm high and 16.00 mm in length. Other sizes and shapes may be possible, but should be designed to ensure that the tip extending from the jacket may be inserted into the phone. The tip may have a length of about 6.65 mm.

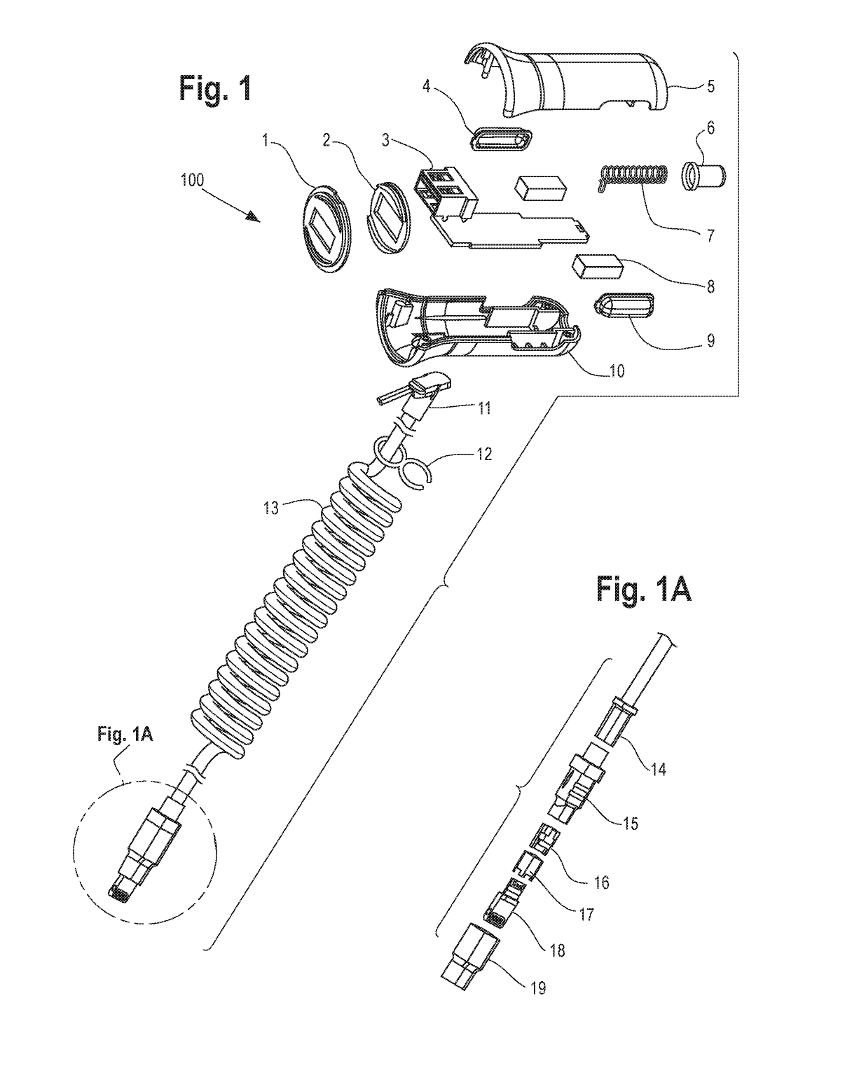

FIGS. 1 and 1A show an example of a car charger in an embodiment. The charger 100 may include a back cover 1, a LED cover 2, a USB female receptor 3, a negative connector 4, an upper cover 5, a positive connector 6, a spring, 7, silicon 8, a negative connector 9, a lower cover 10, a strain relief 11, a cable clip 12, a coil cable, 13, an inner mold 14, a strain relief 15, a Liquid Crystal Polymer (LCP) 16, such as an Apple C408B LCP, an extension holder 17, a connector 18, such an Apple connector C48B, and a jacket or housing 19. The charger 100 may be plugged into a cigarette lighter. Other components for elements 15-18 may be used and the jacket 19 may be configured so that the charger may plug into a device.

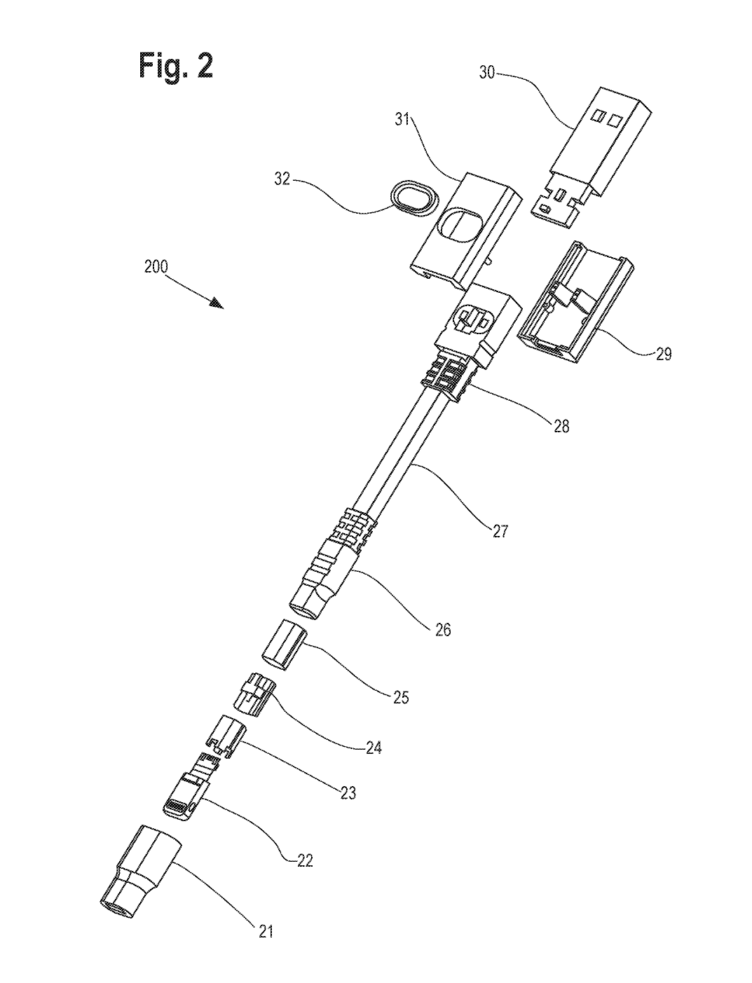

FIG. 2 illustrates a charger 200 with a housing/jacket 21, a connector 22, such as an Apple connector C48B, an extension holder 23, a LCP 24, such as an Apple C408B LCP, an inner mold 25 e.g. an injection mold, a strain relief 26, a flat cable 27, a USB strain relief 28, a lower housing 29, a USB connector 30, an upper housing 31, and an optional decoration piece 32. The charger 200 may be plugged into a device, such as a laptop, tablet, desktop, etc. or may be plugged into a wall outlet or other power source using an adapter. In one embodiment, elements 21-26 of FIG. 2 below may be substantially the same as elements 14-19 of FIG. 1. In another embodiment, elements 1-19 of FIG. 1 may be substantially the same as elements 2-21 in FIG. 2 described below.

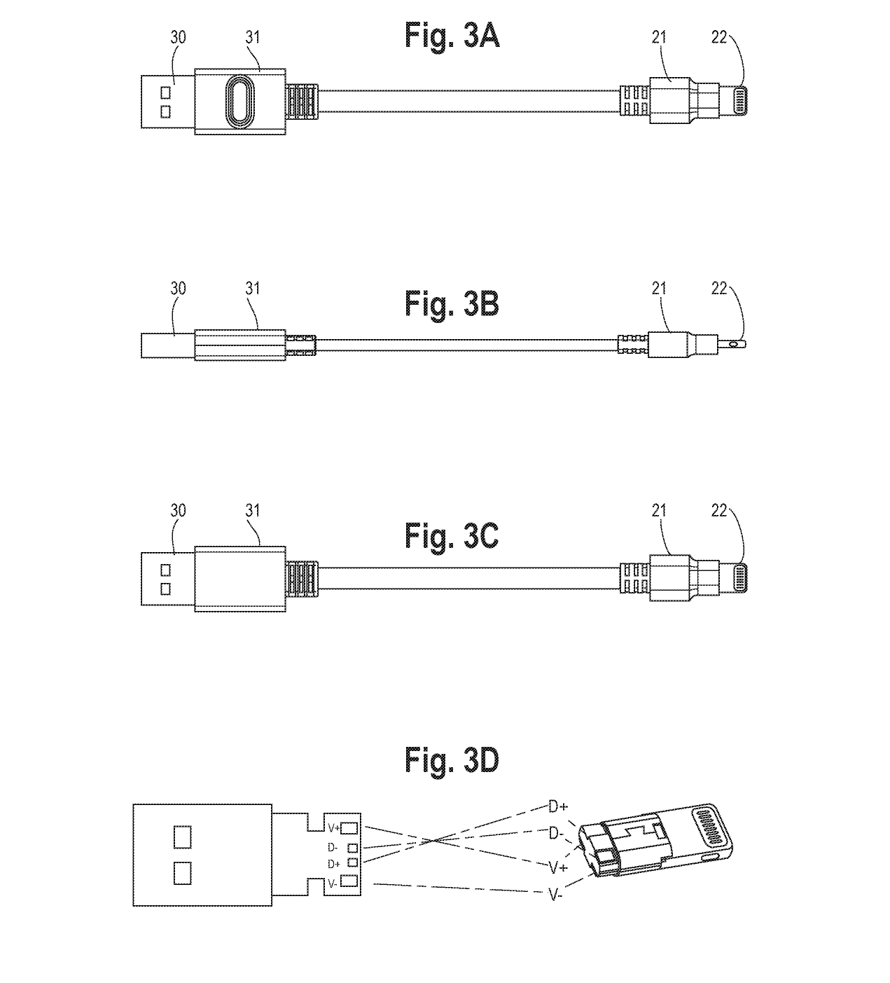

FIGS. 3(A)-3(D) show perspective views of the charger 200. In one embodiment, the USB strain relief 28 may about 7 mm, the jacket 21 may have a length of about 16.00 mm, and a height of about 4.80 mm. The tolerance may vary between +/−0.05 mm-+/−20 mm. As shown in FIG. 3(D), the charger 22 may have corresponding positive and negative voltage pin(s) and D+/D− pins to the chipset.

The described devices, systems and methods have minimal power requirements, no electric cables or complex machinery, low cost construction, and improved stability as compared to other chargers.

The present invention or any part(s) or function(s) thereof, may be implemented using hardware, software, or a combination thereof and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly no stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A charger, comprising:
a first end configured to be plugged into car power outlet, the first end comprising a back cover, an upper cover, a female receptor, a plurality of negative connectors, at least one positive connector, an LED cover; and
a second end coupled to the first end by a cable, the second end including an inner mold, a liquid crystal polymer, a connector, and a jacket; wherein the jacket has a relative dimension to the connector to enable the connecter to engage a charging input of a device, when the device is in a protective cover.

2. The charger of claim 1, wherein the jacket has a length of out 16.00 mm and a height of about 4.80 mm.

3. The charger of claim 1, further comprising a tolerance between +/−0.05 mm-+/−20 mm.

4. The charger of claim 1, wherein the female receptor is a USB female receptor.

5. The charger of claim 1, wherein the cable is a coil cable.

6. The charger of claim 1, wherein the plurality of negative connectors is two.

7. The charger of claim 1, wherein the device is one of a computer, a laptop, a mobile device, and a tablet.

8. The charger of claim 1, further comprising one of a positive and negative voltage pin(s) and one of corresponding D+/D− pins configured on a chipset.
